(19) United States
(12) Patent Application Publication
(10) Pub. No.: US 2009/0188585 A1
(43) Pub. Date: Jul. 30, 2009

(54) Mobile Hand-Held Cutting Device Guide and Support Apparatus

(76) Inventor: Paul Alves, North Danmouth, MA (US)

Correspondence Address: LAMBERT & ASSOCIATES, P.L.L.C., 92 STATE STREET, BOSTON, MA, 02109-2004, US

(21) Appl. No.: 12/021,349

(22) Filed: Jan. 29, 2008

(51) Int. Cl. B27C 5/00; B26D 7/06

(52) U.S. Cl. 144/144.1; 83/435.12

(57) ABSTRACT

A nimble and free moving guide and support apparatus for hand-held cutting devices. The device utilizes vertical support members to maintain contact with a work surface, while a base plate maintains contact with the material to be cut. Above said base plate is mounted a cutting device, such as a router, where the cutting members of said cutting device pass through an opening in said base plate. The nimbleness and free movement of this apparatus are provided by a movement mechanism, such as a ball bearing housed at the end of the vertical support members.

### FIELD OF THE INVENTION

The present invention relates generally to cutting device guide and support structures and more specifically to a new and improved mobile router guide and support apparatus wherein said apparatus comprises a support plate upon which the cutting end of a router will be mounted.

### REFERENCES

In general within the art, descriptions of hand-held cutting guide-and-support devices in U.S. Pat. No. 4,290,719 set forth by Worthington; and U.S. Pat. No. 4,434,824 by Bussey; and U.S. Pat. No. 5,062,460 by Deline; and U.S. Pat. No. 6,792,984 by Fontaine; and U.S. Pat. No. 33,045 by Gronholz; and U.S. Pat. No. 7,089,978 by Karkosch; and U.S. Pat. No. 6,880,595 by Nuss; and U.S. Pat. No. 5,092,234 by Smith; and U.S. Pat. No. 7,281,887 by Taylor.

### BACKGROUND OF INVENTION

Various portable tools have been designed to quickly make accurate and particularly designed cuts in various types of materials. Routers for instance can be used to make cuts into wood to create various designs for any type of wood product. Hand-held routers in particular have the advantages of portability and allow free movement over a cutting surface. However, they have some distinct disadvantages as well.

Hand-held routers, despite their advantages, can be difficult to use at times. Being hand held allows them great flexibility of movement, however, it comes at the price of stability and accuracy. Since these routers are hand-held, they are only as stable as the person holding them. This invariably leads to lost material and time when an errant slip, often even a slight one, can ruin a piece of wood being fabricated for a specific look or design. This has led to the development of various attempts to provide a support means for a number of hand-held cutting tools, including routers.

Previous attempts at support apparatuses for cutting tools such as routers involved using a plate with a handle mounted to it and an opening around which the cutting device would be mounted so that the device's cutting members could contact the surface of the material to be cut as required.

Another attempt mounted the cutting device in a tray that had an opened bottom through which the cutting members made contact with the cutting members made contact with the surface of the material to be cut. In addition this design mounts the tray to two rods that pass through two sets of openings at each end of the tray. These rods in turn are mounted where their two ends pass through an opening in a vertical support piece (so four vertical support pieces in all, two per rod). Each of these vertical support pieces then lie on opposite ends of two horizontal support bars. This allows the tray itself to move in a left-right fashion, while the cutting device within the tray itself may move in a line perpendicular to the movement allowed by the tray along the rods.

Another attempt involved mounting a cutting device to a circular end with an opening through which the cutting members would pass so as to make contact with the cutting surface of the material. In this design the circular end can move up and down along a slide to which the circular end is attached.

Another attempt used a mounting surface with an opening around which the cutting device was mounted and through which the cutting members of the cutting device would pass in order to contact the surface of the material to be cut. This design made use of two bottom-mounted wheels to provide movement along a cutting surface and sliding carriage to move the cutting device for movement away from the cutting surface.

Previous attempts at providing support for hand-held cutting devices fall short of providing all the benefits that the present invention offers. Nothing found in the prior art provides a stable and mobile mounting apparatus that maintains the nimbleness of a free hand-held cutting device that the present invention provides. Some of these prior attempts may allow for vertical and horizontal surface movement, but not in both simultaneously. Those that do allow vertical and horizontal surface movement often do so awkwardly and also lack a convenient method to make adjustments in another dimension (height adjustments). Some of these attempts also involve cumbersome designs with many moving pieces that must be adjusted frequently, which lowers productivity.

What is needed is a mobile but nibble cutting device guide and support apparatus that is easily adjustable for movement in all three dimensions. This invention provides that functionality.

### SUMMARY OF THE INVENTION

The instant invention, as illustrated herein, is clearly not anticipated, rendered obvious, or even present in any of the prior art mechanisms, either alone or in any combination thereof. A mobile hand-held cutting device guide and support apparatus designed to overcome the previously mentioned shortcomings would give users a much more effective means of cutting specific shapes or designs into a select piece of material to be cut. Thus, the several embodiments of the instant invention are illustrated herein.

Therefore, it is an object of the present invention to overcome the previously mentioned shortcomings found in prior art cutting device guide and support systems by providing a mobile hand-held cutting device support apparatus that will move easily and freely along a surface in both the horizontal and vertical directions.

Another object of the present invention is to provide a mobile hand-held cutting device guide and support apparatus that is also easily adjusted in a plane perpendicular to the cutting surface (height adjustment).

Another object of the present invention is to provide a mobile hand-held cutting device guide and support apparatus that provides a measurement means to adjust movement in the plane perpendicular to the cutting surface.

Another object of the present invention is to provide a mobile hand-held cutting device guide and support apparatus with a means for securing various types of cutting devices to itself.

Another object of the present invention is to provide a mobile hand-held cutting device guide and support apparatus that moves along a cutting surface while maintaining contact with the material that is being cut.

Another object of the present invention is to provide a mobile hand-held cutting device guide and support apparatus that may be durable.

Another object of the present invention is to provide a mobile hand-held cutting device guide and support apparatus that may be light weight.

Another object of the present invention is to provide a mobile hand-held cutting device guide and support apparatus whose component parts may be comprised of a variety of metals, metal alloys, metal alloy composites, composites and polymers as well as other materials.

Another object of the present invention is to provide a mobile hand-held cutting device guide and support apparatus that provides a means for securely fastening the cutting device to the apparatuses support plate.

These together with other objects of the invention, along with various features of novelty which characterize the invention, are pointed out with particularity in the claims and Detailed Description of the Embodiments Sections, and drawings of this application, with all said sections also adding to this disclosure.

### BRIEF DESCRIPTION OF THE DRAWINGS

FIG. 1 illustrates an exploded view of one embodiment of the mobile cutting guide apparatus. Visible here are a base plate member, a vertical support member a vertical support member attachment means, a vertical-height-adjustment member, a mobility means (ball bearing), a measurement apparatus, and four representative disk members to which various cutting devices may be attached.

FIG. 2 illustrates an angled front and an angled rear view of the measurement means apparatus as seen in FIG. 1. Also displayed in FIG. 2 is a view of a measurement apparatus attachment means and a securing member for the vertical member attachment means.

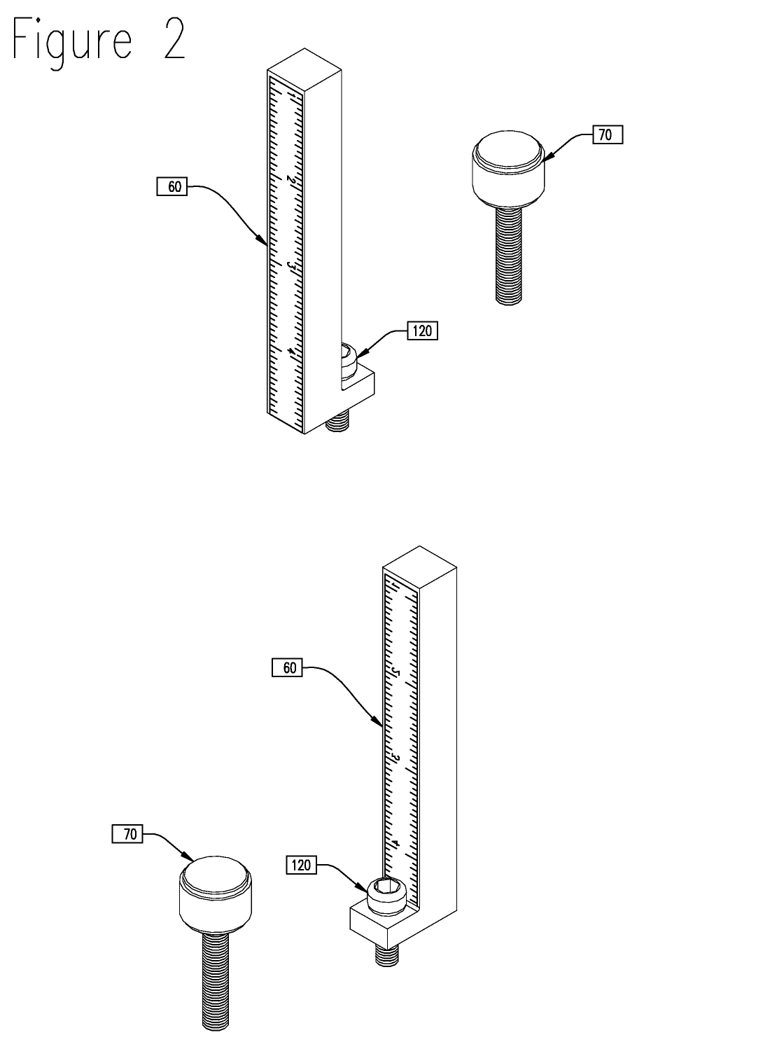

FIG. 3 illustrates a four disk members, each with four open cavities through which a disk member attachment means may pass.

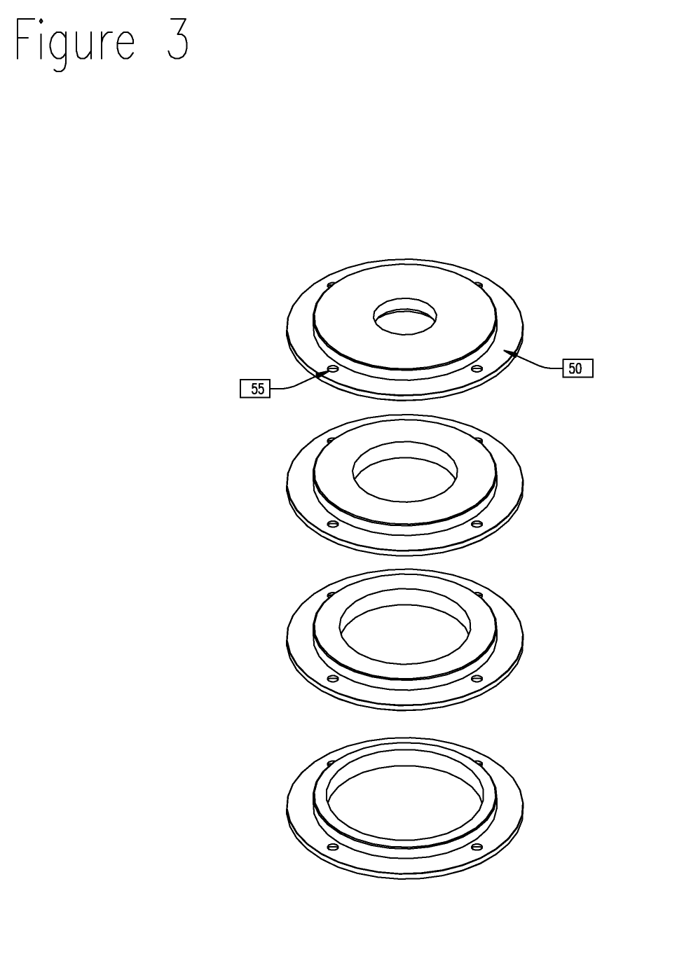

FIG. 4 illustrates a top and bottom view of the base plate member. Visible are a base-plate-to-disk-member ring comprising four open cavities through which disk-member-to-ring attachment members may pass, a vertical-support-member opening through which a vertical-support member may pass, three open cavities about said vertical-support-member opening through which vertical-support-member-to-base-plate attachment members may pass and four open cavities through which base-plate-to-cutting-device attachment means may pass.

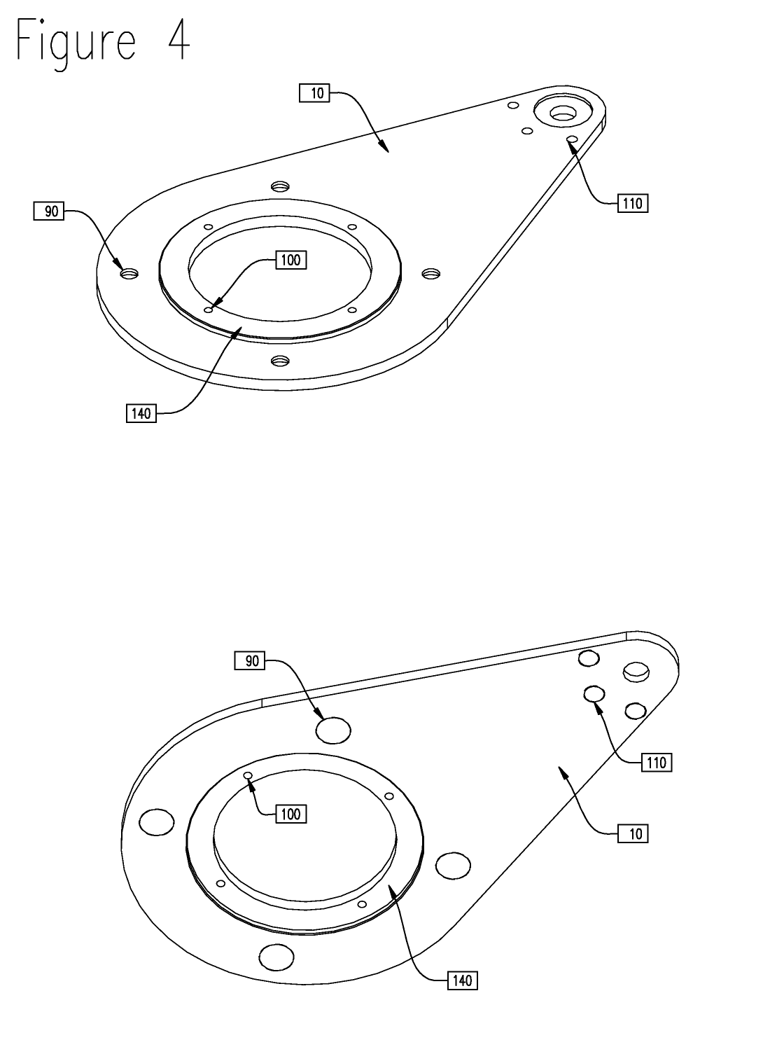

FIG. 5 illustrates a helically-threaded vertical-support member, a movement-means housing attached to said vertical support member and a vertical-height adjustment member.

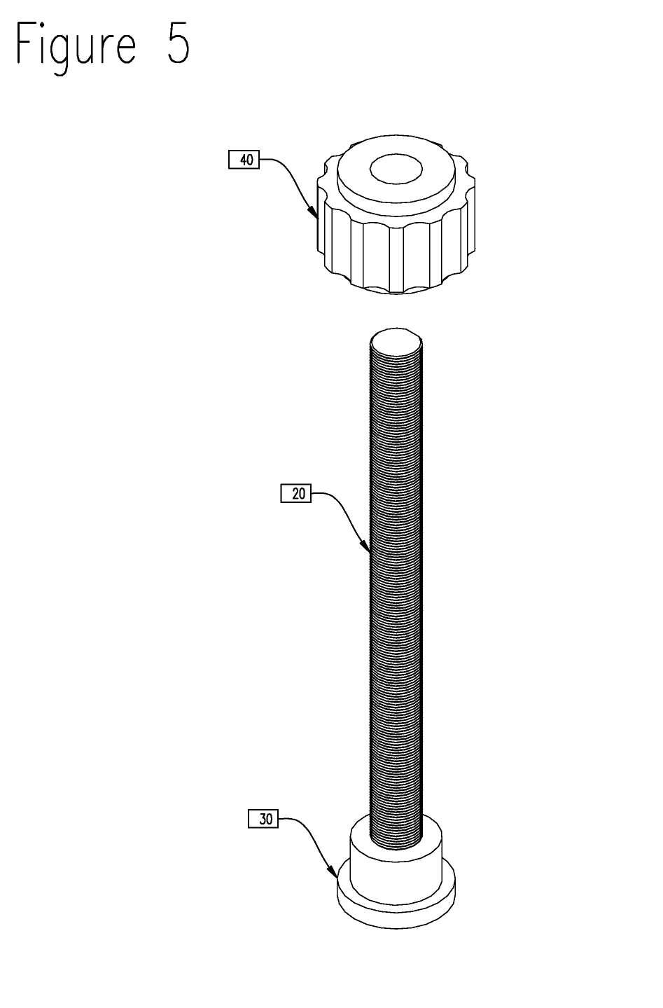

FIG. 6 illustrates an assembled mobile cutting guide apparatus, wherein a base plate member, a base-plate-to-disk-member ring, a vertical support member, a vertical support member attachment means, a vertical-height adjustment means, a mobility-means housing, a mobility means, a measurement means, a measurement means attachment member, four disk members, sixteen (four on each disk member depicted) disk-member-to-base-plate-ring attachment-member open cavities, four base-plate-ring-to-disk-member attachment member open cavities, four base-plate-to-cutting-device attachment-member open cavities, two vertical-support-member-attachment-member-to-measuring-member attachment member open cavities and one vertical-support-member-tightening means open cavity.

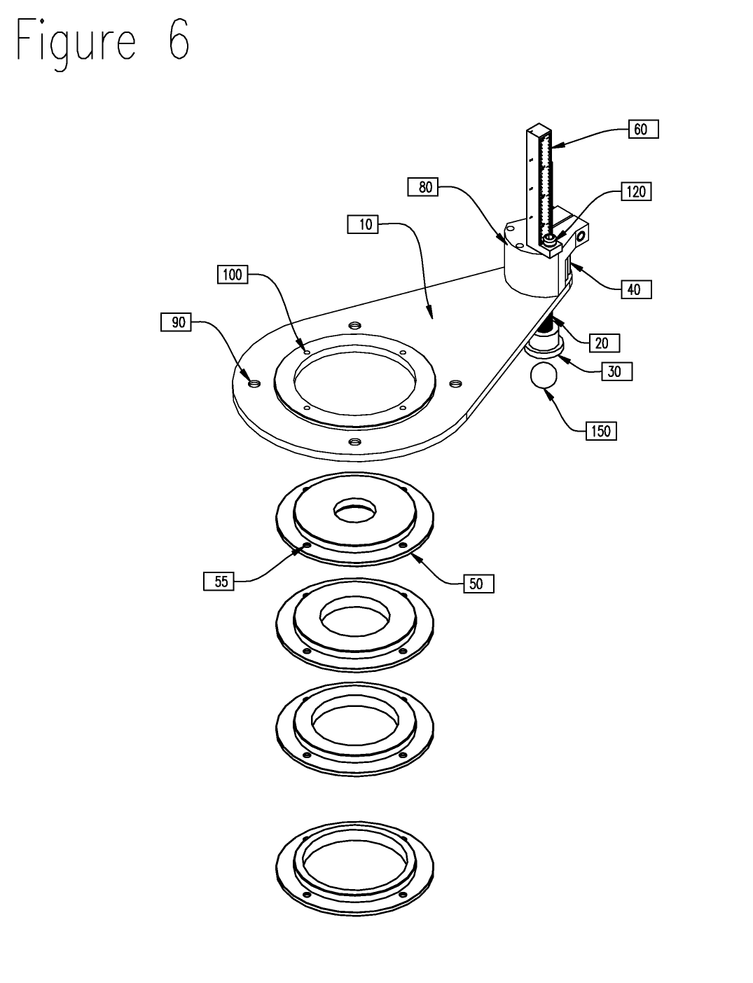

FIG. 7 illustrates an angled front and rear view of the vertical-support-member attachment means. Visible are three vertical-support-member-to-measuring-member attachment member open cavities, and one vertical-support-member-tightening means open cavity.

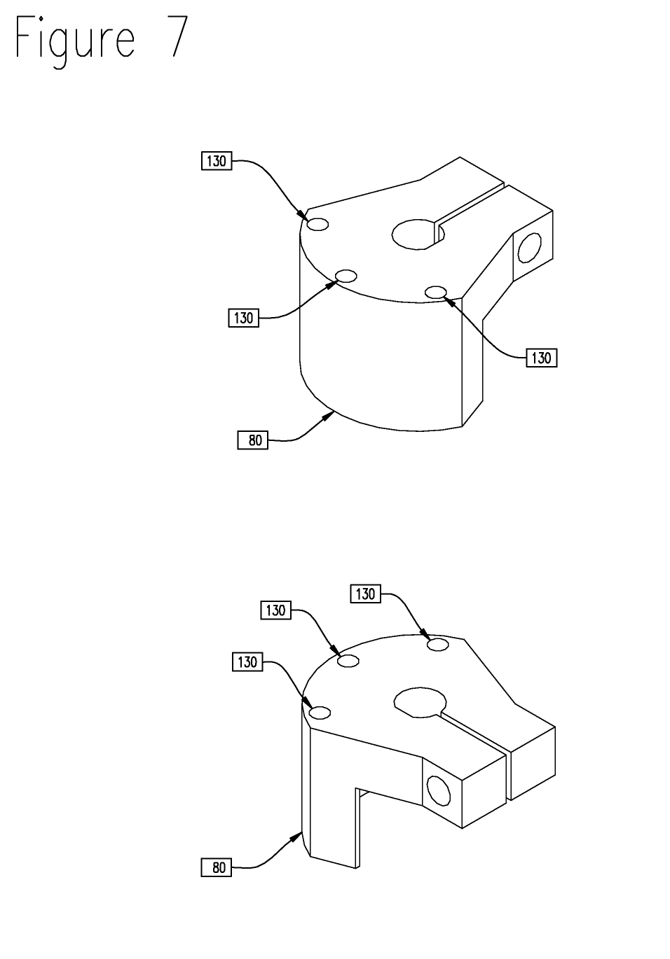

### DETAILED DESCRIPTION OF THE DISCLOSED EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention, such as mobile cutting guides of different shapes, dimensions and different components.

Presently, there are no mobile cutting guides for hand-held cutting tools that are durable and as nimble, as put forth by the present invention. Some previous apparatuses allow for a means to support a cutting device, but fail to provide a means to freely and easily move about a cutting surface.

The present invention solves all these shortcomings by introducing a mobile guide for hand-held cutting tools, which allows a user to freely and easily move the guide along a cutting surface. Further, the use of various disk members allows for this cutting guide to be used with various hand-held cutting devices. This allows users to have an effective way of providing stability while making cuts in a given material, but maintain the advantages gained by having a portable hand-held cutting device. In addition, the ability to modify the height of the vertical support member allows the user to maintain contact with the work surface (to maintain stability) while being able to keep the cutting members of the cutting device in contact with various cutting materials of various dimensions.

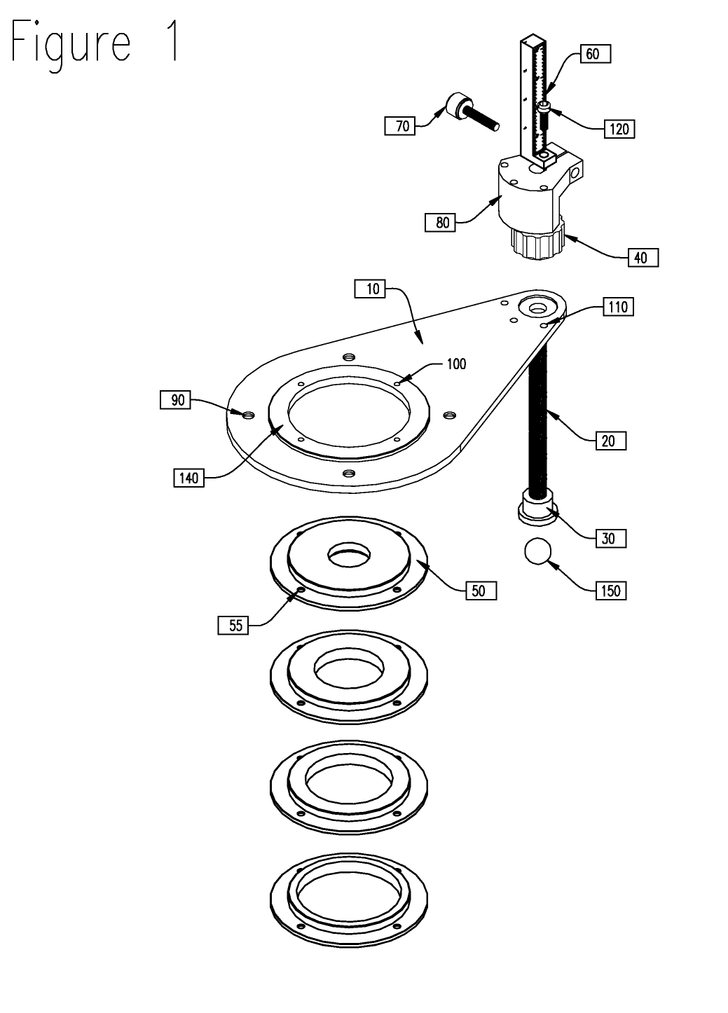

FIG. 1 shows an exploded view of the mobile cutting guide, wherein many of the components for this embodiment are displayed. The base plate 10, comprises a base-plate-to-disk-member ring 140, a base-plate-disk-member opening 15, a vertical-support-member opening 17, a plurality of base-plate-to-cutting-device open attachment cavities 90 about said ring 140 and a plurality of base-plate-to-vertical-support-attachment-member open attachment cavities 110 about said vertical-support-member opening 17. Further said ring 140 further comprising a plurality of base-plate-ring-to-disk-member attachment openings 100 located within said ring 140.

Also depicted in FIG. 1, is a vertical-support member 20 comprising a helically threaded surface, and a mobility-means housing 30 attached to said vertical-support member by an attachment means.

Further, depicted in FIG. 1 is the vertical-height-adjustment member 40 comprising a grooved outer surface for easy gripping and a helically threaded inner surface through which said vertical-support member 20 may pass. Attached to said base-plate member 10 and over said vertical-height adjustment member 40 is the vertical-support-member attachment member 80 comprising a plurality of vertical-support-member-to-measuring-device open cavities 130, one vertical-support-member open tightening-member cavity 88 and one vertical-support-member opening 85 through which the vertical-support-member 20 may pass. Said vertical-support-member attachment member 80 being placed over said vertical-height adjustment member 40, so that as said vertical-height adjustment member 40 is rotated left or right said vertical-support member's 20 height will raised or lowered relative to the distance between said the mobility-means housing 30 and where the vertical-support member contacts the bottom of said base plate 10.

Further depicted in FIG. 1 is a measurement member 60, removably attached to said vertical-support-member attachment member 80 by a measurement-member attachment means member 120 that pass through a plurality of measurement-member-to-attachment-means open cavities 130. Measurements being made by said measurement 60 member by comparing the height of said vertical-support member 20 found above said vertical-support-member-attachment member 80 to the given units of measure on said measurement member 60.

Further depicted in FIG. 1 is the vertical-support-member-attachment-member tightening member 70 which may pass through said vertical-support-member open tightening-member cavity 85 so as to securely hold said vertical-support-member 20.

Further depicted in FIG. 1 is the mobility means member 150, here shown as a ball bearing, held within said mobility-means housing 30 by a holding means.

Further depicted in FIG. 1 is a plurality of disk members 50, comprising a plurality of disk-member-to-ring open attachment cavities 55 and one central cutting-device-cutting-member opening 57. Said disk members 50 being removably attached to said base-plate ring 140 by an attachment means passing through said attachment cavities 55 and 100.

In other embodiments of this invention the dimensions, shapes and construction materials of the mobile cutting device apparatus may vary. In these other embodiments the shapes and dimensions of said cutting guide may also vary, including but not limited to, the dimensions of all openings and cavities comprised within said base plate member 10. In addition, the dimensions and the units of measure associated with said measurement member 20 may vary. Further the dimensions of the disk members 50 may vary including the dimensions of said cutting-device-cutting-members central opening 57. Further, the type of mobility member used may also vary in other embodiments, including but not limited to, removably attached tread members attached to said vertical support member or removably attached to said mobility means housing member.

What is claimed is:

1. A mobile hand-held cutting device guide and support apparatus comprising:
a base-plate member;
a vertical-support member removably attached to said base plate member;
a vertical-height-adjustment member comprising a vertical-support-member opening through which said vertical-support member may pass removably attached to said vertical-support member;
a vertical-support-member-attachment device removably attached to said vertical-support-member and said base-plate member; and
a mobility means.

2. The mobile hand-held cutting device guide and support apparatus of claim 1, wherein the base plate member further comprises:
at least one vertical-support-member opening;
a plurality of base-plate-to-cutting-device open attachment cavities located about said ring;
a plurality of base-plate-to-cutting-device open attachment cavities;
a plurality of base-plate-to-vertical-support-attachment-member open attachment cavities;
at least one base-plate-to-disk-member ring comprising a plurality of open base-plate-ring-to-disk-member attachment cavities; and
at least one base-plate-to-disk-member opening.

3. The mobile hand-held cutting device guide and support apparatus of claim 2, wherein the vertical-support-member-attachment device further comprises:
a plurality of vertical-support-member-to-measuring-device open cavities;
at least one vertical-support-member tightening-member cavities; and
at least one vertical-support-member openings through which a vertical-support member may pass.

4. The mobile hand-held cutting device guide and support apparatus of claim 3 further comprising:
a plurality of disk members comprising;
at least one central cutting-device-cutting-member central opening; and
a plurality of disk-member-to-ring open attachment cavities;
wherein said disk members are removably attached to said base-plate ring by an attachment means removably attaching said ring-to-disk-member openings and said disk-member-to-ring cavities.

5. The mobile hand-held cutting device guide and support apparatus of claim 3 further comprising: a measuring device member removably attached to said vertical-support-member-attachment device by an attachment means.

6. The mobile hand-held cutting device guide and support apparatus of claim 4 further comprising: a measuring device member removably attached to said vertical-support-member-attachment device by an attachment means.

7. The mobile hand-held cutting device guide and support apparatus of claim 6, wherein the vertical-support member further comprises a helically threaded surface and a removably attached movement-member housing.

8. The mobile hand-held cutting device guide and support apparatus of claim 7, wherein the vertical-height adjustment member further comprises: a grooved exterior surface and said adjustment member's vertical-support-member opening further comprises a helically-threaded interior surface.

9. The mobile hand-held cutting device guide and support apparatus of claim 8, wherein the movement member is removably attached to said vertical-support member housing and further comprises a member selected from the group consisting of a wheel member, a tread member and a ball bearing member.

10. A mobile hand-held cutting-router guide and support apparatus comprising:
a base-plate member comprising:
at least one base-plate-to-disk-member ring comprising a plurality of open base-plate-ring-to-disk-member attachment cavities;
at least one base-plate-to-disk-member opening;
at least one vertical-support-member opening;
a plurality of base-plate-to-cutting-device attachment cavities located about said ring;
a plurality of base-plate-to-cutting-device attachment cavities;
a plurality of base-plate-to-vertical-support-attachment-member attachment cavities;
a vertical-support member removably attached to said base plate member;
a plurality of disk members comprising;
at least one central cutting-device-cutting-member central opening; and
a plurality of disk-member-to-ring open attachment cavities, wherein said disk members are removably attached to said base-plate ring by an attachment means that removably attaches said ring-to-disk-member openings and said disk-member-to-ring cavities;
a vertical-height-adjustment member comprising a vertical-support-member opening disposed to allow said vertical-support member to pass and wherein said vertical-height adjustment member is removably attached to said vertical-support member;
a measuring device member removably attached to said vertical-support-member-attachment member by an attachment means;
a vertical-support-member-attachment component removably attached to said vertical-support-member and said base-plate member, further comprising;
a plurality of vertical-support-member-to-measuring-device open cavities;
at least one vertical-support-member tightening-member cavities;
at least one vertical-support-member openings through which a vertical-support member may pass; and
a mobility means.

11. The mobile hand-held cutting device guide and support apparatus of claim 10, wherein the vertical-support member further comprises: a helically threaded surface and a removably attached movement-member housing.

12. The mobile hand-held cutting device guide and support apparatus of claim 11, wherein the vertical-height adjustment member further comprises: a grooved exterior surface and said adjustment member's vertical-support-member opening further comprises a helically-threaded interior surface.

13. The mobile hand-held cutting device guide and support apparatus of claim 12, wherein the movement member is removably attached to said vertical-support member housing and further comprises a ball bearing member.

14. The mobile hand-held cutting device guide and support apparatus of claim 12, wherein the movement member is removably attached to said vertical-support member housing and further comprises a tread member.

15. A method of using a mobile hand-held cutting device and support apparatus to provide stability for a hand-held cutting device while making cuts, comprising the steps of:
attaching a hand-held cutting device to said support apparatus so that the cutting members of said cutting device may pass through said apparatus;
placing said cutting members of said cutting device onto the surface of a material to be cut;
moving about the apparatus in such as fashion so as to make the necessary cuts to said material as required.

16. The method of using a mobile hand-held cutting device and support apparatus to provide stability for a hand-held cutting device while making cuts of claim 15, wherein said apparatus comprises:
a base-plate member comprising;
at least one vertical-support-member opening;
a plurality of base-plate-to-cutting-device open attachment cavities located about said ring;
a plurality of base-plate-to-cutting-device open attachment cavities;
a plurality of base-plate-to-vertical-support-attachment-member open attachment cavities;
a vertical-support member removably attached to said base plate member;
a vertical-height-adjustment member comprising a vertical-support-member opening through which said vertical-support member may pass removably attached to said vertical-support member;
at least one base-plate-to-disk-member ring comprising a plurality of open base-plate-ring-to-disk-member attachment cavities;
at least one base-plate-to-disk-member opening;
a plurality of disk members comprising;
at least one central cutting-device-cutting-members central opening;
a plurality of disk-member-to-ring open attachment cavities, wherein said disk members are removably attached to said base-plate ring by an attachment means that removably attaches said ring-to-disk-member openings and said disk-member-to-ring cavities;
a vertical-support-member-attachment member removably attached to said vertical-support-member and said base-plate member, further comprising;
a plurality of vertical-support-member-to-measuring-device open cavities;
one or more vertical-support-member open tightening-member cavities;
one or more vertical-support-member openings through which a vertical-support member may pass; and
a mobility means.

17. The method of using a mobile hand-held cutting device and support apparatus to provide stability for a hand-held cutting device user while making cuts of claim 16, wherein said apparatus further comprises a measuring device member removably attached to said vertical-support-member-attachment member by an attachment means.

18. The method of using a mobile hand-held cutting device and support apparatus to provide stability for a hand-held cutting device user while making cuts of claim 17, wherein the vertical-support member further comprises a helically threaded surface and a removably attached movement-member housing.

19. The method of using a mobile hand-held cutting device and support apparatus to provide stability for a hand-held cutting device user while making cuts of claim 18, wherein the vertical-height adjustment member further comprises: a grooved exterior surface and said adjustment member's vertical-support-member opening further comprises a helically-threaded interior surface.

20. The method of using a mobile hand-held cutting device and support apparatus to provide stability for a hand-held cutting device user while making cuts of claim 19, wherein the movement member chosen from the group consisting of a wheel, a tread and a ball bearing.
